(19) United States
(12) Patent Application Publication
(10) Pub. No.: US 2026/0356083 A1
(43) Pub. Date: Nov. 12, 2026

(54) ILLUMINABLE GLAZING

(71) Applicant: SAINT-GOBAIN SEKURIT FRANCE, THOUROTTE (FR)

(72) Inventors: Siyamak MEMAR JAVID, HERZOGENRATH (DE); Sebastian ARENDT, HERZOGENRATH (DE); Yahya MOTEMANI SHARABIANI, HERZOGENRATH (DE); Klaus FISCHER, HERZOGENRATH (DE); Florence JACQUES, HERZOGENRATH (DE)

(21) Appl. No.: 19/137,980

(22) PCT Filed: Dec. 11, 2023
(86) PCT No.: PCT/EP2023/085025

§ 371 Date: Jun. 11, 2025

(30) Foreign Application Priority Data
Dec. 12, 2022 (EP) 22212754.0

(51) Int. Cl. B32B 17/10; F21V 8/00

(52) U.S. Cl. CPC B32B 17/10541; B32B 17/10036; G02B 6/0016; G02B 6/0065; B32B 2250/03; B32B 2255/20; B32B 2307/416; B32B 2307/418; B32B 2315/08; B32B 2605/00; G02B 6/0095

(57) ABSTRACT

A glazing includes at least a first pane having a first main surface and a second main surface, a coating having a first main surface and a second main surface, wherein the coating is arranged with the first main surface on the second main surface of the first pane, at least one light source, wherein the light source is connected to the coating such that light from the light source can be coupled into the coating, and at least one light outcoupling device for coupling light out of the coating via at least one of the main surfaces, wherein, for at least one wavelength λ of a light from the light source, a refractive index n₂₀ of the coating is greater than a refractive index n₁ of the first pane, and an extinction coefficient k₂₀ of the coating is smaller than an extinction coefficient k₁ of the first pane.

The invention relates to an illuminable or illuminated glazing, preferably as a single pane or laminated pane and in particular a roof pane.

In illuminated glazings or light distribution systems, light is usually coupled into a flat light guide of the glazing by utilizing the effect of total reflection, which is known, for example, from WO 2008/047442 A1, JP 2011 086547 A or JP 2015 043321 A.

WO 2010/049638 A1, WO 2013/053629 A1, WO 2014/060409 A1, WO 2015/095288 A2 or WO 2022/218741 A1 disclose to couple light via the side surface (also referred to as side edge) of a glass pane. If the light source is placed very close to the glass edge, light can be thereby coupled into the light guide very efficiently and over the entire width of the light guide. A very homogeneous planar illumination can thereby be achieved. This principle is well known and very common, e.g., for display backlighting and decorative lighting applications.

In other applications, for example in the case of a roof pane of a vehicle glazing in the automotive sector, such light coupling via one of the side surfaces is difficult because it is glued into the body of the vehicle and the pane typically has a rounded edge, the so-called C-cut. Since the side surface must be as smooth as possible for the most efficient light coupling, complex smoothing and polishing or other special processing of the side surface is required.

From WO 2013/110885 A1, WO 2018/178591 A1 or WO 2019/105855 A1 it is known to insert light sources into recesses, for example in mechanically drilled holes, and to thereby couple light into the glass pane. However, punctiform light coupling makes it difficult to achieve homogeneous illumination of the entire pane. Furthermore, the edge of the borehole is matt for technical reasons, which also reduces the efficiency of light coupling. Also, the boreholes result in a mechanical weakening of the glazing.

Alternatively, the light source can be arranged on one of the main surfaces of the glass pane and the light can be coupled into the glass pane via one of the main surfaces, which is known, for example, from WO 2022/096365 A1 .

In WO 2014/060409 A1, an additional single safety pane is mounted by means of a casing or housing under the actual laminated glass pane, the sole function of which is that of a light guide. This leads to considerable additional production costs and additional weight and space requirements for the entire roof pane.

Now, the object of the present invention is to provide an improved glazing which can be produced in a simple and cost-effective manner and which enables particularly efficient illumination of the glazing.

The object of the present invention is achieved according to the invention by a glazing according to independent claim 1. Preferred embodiments are apparent from the dependent claims.

The glazing according to the invention comprises at least the following features:
at least a first pane having a first main surface and a second main surface,
a coating having a first main surface and a second main surface, wherein the coating is arranged with the first main surface on the second main surface of the first pane,
at least one light source, wherein the light source is connected to the coating such that light from the light source can be coupled into the coating, and
at least one light outcoupling means for coupling light out of the coating via at least one of the main surfaces,
   wherein, for at least one wavelength λ of a light from the light source,
a refractive index n₂₀ of the coating is greater than a refractive index n₁ of the first pane, and
an extinction coefficient k₂₀ of the coating is smaller than an extinction coefficient k₁ of the first pane.

In an advantageous embodiment of the glazing according to the invention, the light source is connected to the coating according to the invention such that light from the light source can be coupled at an angle θ greater than or equal to the angle θₜₒₜₐₗ of total reflection in the coating.

In another advantageous embodiment of the glazing according to the invention, the light source is configured such that the light is substantially not coupled into the first pane or another (e.g., second) pane. In particular, the light is not coupled into the coating via the first pane.

The present invention is based on the following finding of the inventors: glass —be it mineral glass, such as soda lime glass, or polymeric glass—is often described as transparent. By utilizing total reflection, light coupled into a glass pane can be retained in the glass with almost no reflection losses at the interfaces to other media (such as air). However, even in glass, there is a generally wavelength-dependent extinction and thus a loss of intensity that increases with the length of the path in the medium. This is particularly disadvantageous in tinted glass panes or arrangements in which the light source is far away from the location where the light is coupled out.

In the present invention, a coating is arranged on the first pane which a) has a higher refractive index and thus forms a planar optical waveguide and b) the extinction coefficient of which is low so that less coupled light is lost along the propagation in the medium. The combination of both allows a high light intensity that can be coupled out, even at positions on the glazing that are far away from the respective light source.

In an advantageous embodiment of a glazing according to the invention, the light source (4) is suitable for emitting light of at least one wavelength λ in the wavelength range of visible light (VIS), preferably in the range of 380 nm to 780 nm.

In another advantageous embodiment of a glazing according to the invention, the extinction coefficient k₂₀ of the coating is smaller than the extinction coefficient k₁ of the first pane by a factor of at least 1.5, preferably at least 2, particularly preferably at least 5 and in particular at least 10.

In another advantageous embodiment of a glazing according to the invention, the extinction coefficient k₂₀ at a wavelength λ of 550 nm is less than or equal to 1*10⁻⁶, preferably less than or equal to 1*10⁻⁷ and particularly preferably less than or equal to 1*10⁻⁸.

In another advantageous embodiment of a glazing according to the invention, the coating has a substantially constant thickness d₂₀.

In another advantageous embodiment of a glazing according to the invention, the coating has a thickness d₂₀ of at least the minimum wavelength λ of the light from the light source.

In another advantageous embodiment of a glazing according to the invention, the coating has a thickness d₂₀ of 380 nm to 10 μm, preferably of 780 nm to 5 μm, and in particular of 800 nm to 2 μm.

In another advantageous embodiment of a glazing according to the invention, the coating is deposited on the second main surface of the first pane by a thin-film deposition process.

In a particularly advantageous embodiment of the invention, the coating according to the invention is deposited by methods known per se, preferably by cathodic sputtering or magnetic field-assisted cathodic sputtering. This is particularly advantageous in terms of a simple, rapid, inexpensive, and uniform coating of the substrate. Cathodic sputtering takes place in an inert gas atmosphere, for example of argon, or in a reactive gas atmosphere, for example by adding oxygen or nitrogen.

However, coatings according to the invention can also be applied by other methods known to those skilled in the art, for example by vapor deposition or chemical vapor deposition (CVD), by plasma-enhanced chemical vapor deposition (PECVD) or by wet chemical methods, for example sol-gel processes such as spray coating, dip coating, spin coating or casting.

In general, sol-gel processes are understood to mean the condensation of colloidally dissolved particles into three-dimensional networks, wherein the size of the colloids can vary between 1 nm and several 1000 nm. In spray coating, a sol is atomized by supplying a certain amount of air and is then transported to the substrate in very small particles. In dip coating, the substrate is dipped into a solution and then pulled out again at a constant speed. In the casting process, a synthesis solution is dripped onto the substrate and the solvent is allowed to evaporate. The production of coatings by casting is also based on the evaporation-induced self-assembly (EISA) mechanism. The films produced in this way can be significantly thicker than those produced by dip or spin coating.

Chemical vapor deposition (CVD) or plasma-enhanced chemical vapor deposition (PECVD) is particularly preferred for producing silicon dioxide-containing coatings or coatings consisting of silicon dioxide, in which the coating is formed by a reaction of gases containing silicon, such as silane or tetraethylorthosilicate (TEOS, also referred to as tetraethoxy silane).

In another advantageous embodiment of a glazing according to the invention, the coating contains or consists of titanium oxide, aluminum oxide, silicon nitride, in particular Si₃N₄, silicon zirconium nitride, silicon oxynitride and/or silicon dioxide, in particular SiO₂.

In another advantageous embodiment of a glazing according to the invention, the refractive index n₂₀ of the coating is at least 0.1, preferably at least 0.2 and in particular at least 0.2 to 1.5, greater than the refractive index n₁ of the first pane.

In another advantageous embodiment of the invention, the glazing according to the invention comprises at least one, preferably transparent, light coupling means, wherein the light source is connected to the first main surface of the coating via the light coupling means, so that light from the light source can be coupled into the coating.

Transparent within the meaning of the invention is understood to mean an object, in particular a light coupling means, a light outcoupling means and/or a transparent body, which has a transmission in the visible spectral range of greater than 20%, preferably greater than 50%, particularly preferably greater than 70%, in particular greater than 85%.

In an advantageous embodiment of the glazing according to the invention, the light coupling means is suitable for deflecting some of the light arriving from the light source in transmission by scattering, reflection, refraction or diffraction.

In another advantageous embodiment of the glazing according to the invention, the light coupling means is suitable for coupling some of the light arriving from the light source into the coating at an angle θ greater than or equal to the angle θₜₒₜₐₗ of total reflection in the coating. The angle θ is the angle of incidence or reflection with respect to the perpendicular to the main surface of the pane. Advantageously, the portion of light coupled into the coating from the light source at an angle θ greater than or equal to the angle θₜₒₜₐₗ of total reflection is increased by the light coupling means by a factor of at least 50, preferably at least 200.

In an advantageous embodiment, the light coupling means is introduced into the second main surface of the coating, preferably by laser structuring, mechanical structuring such as sandblasting, and/or etching, preferably chemical or physical etching. A flat, irregular surface structure which leads to diffuse light scattering when illuminated is particularly suitable. Alternatively, linear or grid-shaped (e.g., cross-grid-shaped) structures can be introduced.

In another advantageous embodiment, the light coupling means according to the invention is not formed integrally with the coating.

In an alternative advantageous embodiment, the light coupling means is printed on the second main surface of the coating, for example by inkjet or screen printing. Advantageously, the print contains particles that are suitable for scattering, refracting, diffracting or reflecting light.

In another alternative advantageous embodiment, the light coupling means contains or consists of a transparent body which is integrally connected to the second main surface of the coating, for example by gluing.

The transparent body according to the invention preferably contains or consists of a structured plastic film or plastic plate, for example with light-scattering, light-refracting, light-diffracting or light-reflecting particles, or a holographic film. The transparent body according to the invention can also contain or consist of a planar arrangement of microprisms, for example of randomly or grid-like arranged pyramids or of linearly arranged steps (hereinafter also referred to as step prism). The transparent body typically has a surface structure made up of such microprisms. Such microprisms can advantageously be produced by mechanical processing such as stamping or embossing, by chemical etching, by photolithography or other transfer techniques.

The refractive index n₁₀ of the transparent body is preferably from n₁−0.3 to n₁+0.3, particularly preferably from n₁−0.2 to n₁+0.2 and in particular from n₁−0.15 to n₁+0.15, wherein n₁ is the refractive index of the first pane.

In another alternative advantageous embodiment, the light coupling means and in particular the transparent body is part of the light source, for example a portion of the housing.

In an advantageous embodiment of the invention, the light source is connected to the coating directly or only via the light coupling means. The light source is in particular configured such that the light is not coupled into the first pane or another pane.

It shall be appreciated that a glazing according to the invention can have one or more light sources, the light of which is coupled into the coating according to the invention by one or more of the light coupling means described above, wherein different light coupling means can also be combined in one glazing.

In an advantageous embodiment of a glazing according to the invention, the light source is suitable for emitting visible light.

In an advantageous embodiment of a glazing according to the invention, the light source contains or consists of at least one light-emitting diode (LED), preferably at least one organic light-emitting diode (OLED), at least one laser diode, at least one incandescent lamp, and/or at least one gas discharge lamp. A light source having a plurality of laser or light-emitting diodes, which are arranged in particular in a strip shape on a carrier strip, is particularly advantageous.

In a particularly advantageous embodiment of a glazing according to the invention, the light source and in particular the plurality of laser or light-emitting diodes are arranged in a meandering, wave-shaped or zigzag-shaped manner on the coating according to the invention, in particular in the form of a circle or loop. This allows a particularly large amount of light to be coupled into the coating.

In an advantageous embodiment of the glazing according to the invention, the light outcoupling means is suitable for coupling out some of the light guided into the coating according to the invention, preferably by scattering, reflection, refraction or diffraction, on at least one of the main surfaces of the coating.

Advantageously, the light outcoupling means is introduced into the first main surface, into the second main surface and/or within the coating according to the invention, and/or arranged on the first main surface and/or on the second main surface.

For this purpose, the light outcoupling means is preferably introduced by laser structuring, mechanical structuring such as sandblasting, and/or by etching into the first main surface and/or the into the second main surface of the coating according to the invention.

Alternatively or in combination, the light outcoupling means can be integrally connected to the first main surface and/or the second main surface of the coating according to the invention, preferably by printing or gluing of a colorant, a paste or particles, particularly preferably of light-scattering, light-refracting or light-reflecting particles.

Alternatively or in combination, the light outcoupling means can comprise or consist of particles, particularly preferably light-scattering, light-refracting, light-diffracting or light-reflecting particles, scattering centers or cavities, which are arranged within the coating according to the invention. Such scattering centers or cavities can be introduced into the coating for example by laser structuring.

Alternatively or in combination, the light outcoupling means can contain or consist of at least one transparent body which is integrally connected to the first or second main surface of the coating according to the invention, for example by gluing or arranging it on the first pane before applying the coating, wherein the transparent body preferably contains or consists of
a) a structured plastic film or plastic plate or
b) a transmission-holographic film.

Advantageously, the structured plastic film or plastic plate has a planar arrangement of microprisms, such as a step prism.

Alternatively or in combination, the light outcoupling means can be a reflective body which is integrally connected to the second or first main surface of the coating according to the invention, for example by gluing, wherein the reflective body preferably contains or consists of
a) a structured plastic film or plastic plate or
b) a transmission-holographic film. Advantageously, the structured plastic film or plastic plate has a planar arrangement of microprisms, such as a step prism.

If such a light outcoupling means is arranged, for example, on the second main surface of the coating according to the invention, the light is coupled out, for example, via the second main surface and can be seen by an observer looking at the coating according to the invention via the second main surface.

Alternatively or in combination, the light outcoupling means can be a transparent body which is—preferably integrally—connected to the first or second main surface of the coating according to the invention, for example by gluing. Advantageously, the transparent body then contains or consists of a preferably structured, particularly preferably a diffuse-scattering or directionally refracting, for example by microprisms, transparent layer, plastic film or plastic plate, the refractive index n_{10′} of which is significantly greater than n₁. In particular, n₁₀ is then greater than n₁ by at least +0.2 or by at least +0.5. Such a light coupling means can, for example, be a roughened film coated with titanium oxide (TiOx). If such a light outcoupling means is arranged, for example, on the second main surface of the coating according to the invention, the light is coupled out, for example, via the second main surface and can be seen by an observer looking at the coating according to the invention via the second main surface.

The transparent body according to the invention of the light outcoupling means can contain or consist of a planar arrangement of microprisms, for example of randomly or grid-like arranged pyramids or of linearly arranged steps (hereinafter also referred to as step prism). The transparent body typically has a surface structure made up of such microprisms. Such microprisms can advantageously be produced by mechanical processing such as stamping or embossing, by chemical etching, by photolithography or other transfer techniques.

In an advantageous development of the invention, the glazing according to the invention has at least one light amplification means. The light amplification means is arranged opposite the light coupling means with respect to the coating according to the invention. Opposite here preferably means that the light amplification means is arranged at least in the region of the orthogonal projection of the light coupling means onto the coating according to the invention.

The light amplification means can be arranged directly between the first main surface of the coating and the second main surface of the first pane. In particular, the light amplification means is not formed integrally with the coating.

The light amplification means according to the invention is in particular suitable for redirecting light emerging from the coating into the coating by reflection, preferably directed reflection, scattering, preferably diffuse scattering, or diffraction, preferably at an angle θ greater than or equal to θₜₒₜₐₗ.

In an advantageous embodiment of the invention, the glazing is a single glazing, for example a single pane.

In an alternative embodiment, the glazing according to the invention is a laminated pane. A second pane is preferably connected to the first main surface of the first pane by at least one intermediate layer, preferably by lamination.

In principle, all electrically insulating substrates that are thermally and chemically stable as well as dimensionally stable under the conditions of production and of use of the composite pane according to the invention are suitable as the first pane and the second pane.

The first pane and/or, if present, the second pane preferably contains or consists of glass, particularly preferably flat glass, most particularly preferably float glass, such as soda lime glass, borosilicate glass, or quartz glass, or clear plastics, preferably rigid clear plastics, in particular polyethylene, polypropylene, polycarbonate, polymethyl methacrylate, polystyrene, polyamide, polyesters, polyvinyl chloride, and/or mixtures thereof. The first pane and/or the second pane are preferably transparent, in particular for the use of the panes as a windshield or rear window of a vehicle or other uses where high light transmission is desired. In the sense of the invention, “transparent” refers to a pane that has a transmission greater than 70% in the visible spectral range. In particular, at least the first pane and preferably also the second pane consists of clear glass.

However, for panes that are not situated in the traffic-relevant field of vision of the driver, for example, for roof panes, transmission can also be much lower, for example, greater than 5%. For this purpose, for example, the second pane and/or the intermediate layer can be tinted or colored.

The thickness of the first pane and/or the second pane can vary widely and thus be ideally adapted to the requirements of the individual case. Preferably, standard thicknesses of 1.0 mm to 25 mm, preferably of 1.4 mm to 2.5 mm, are used for vehicle glass, and preferably of 4 mm to 25 mm are used for furniture, devices and buildings. The size of the panes can vary widely and depends upon the size of the use according to the invention. The first and the second panes have surfaces from 200 cm² up to 20 m², as is usual, for example, in vehicle construction and the architectural sector.

The glazing can have any three-dimensional shape. Preferably, the three-dimensional shape has no shadow zones so that they can be coated with further coatings, for example, by cathodic sputtering. Preferably, the panes are planar or slightly or markedly curved in one or more spatial directions. In particular, planar substrates are used. The panes can be colorless or tinted.

In case of a laminated pane, the first pane and the second pane are connected to one another by at least one intermediate layer. The intermediate layer is preferably transparent or tinted or colored. The intermediate layer preferably contains or is made of at least one plastics, preferably polyvinyl butyral (PVB), ethylene vinyl acetate (EVA), and/or polyethylene terephthalate (PET). The intermediate layer can, however, also contain for example polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylene, polyvinyl fluoride, and/or ethylene tetrafluoroethylene, or copolymers or mixtures thereof. The intermediate layer can be formed by one or even by a plurality of films arranged one over another, wherein the thickness of a film is preferably from 0.025 mm to 1 mm, typically 0.38 mm or 0.76 mm. The intermediate layers can preferably be thermoplastic, and, after lamination, the first pane, the second pane, and any other intermediate layers can be bonded to one another. Particularly advantageous are so-called acoustic-damping intermediate layers which preferably consist of three layers of PVB, wherein the middle layer is designed to be softer than the two outer layers.

The intermediate layer can also be a functional intermediate layer, in particular an intermediate layer reflecting infrared radiation, an intermediate layer absorbing infrared radiation, an intermediate layer absorbing UV radiation, an at least sectionally colored intermediate layer, and/or an at least sectionally tinted intermediate layer. For example, the thermoplastic intermediate layer can also be a bandpass filter film.

The terms “first pane” and “second pane” have been chosen in order to differentiate the two panes of a laminated pane according to the invention. No statement about geometric arrangement is associated with the terms. When the laminated pane according to the invention is, for example, provided in an opening in, for example, a vehicle or a building, in order to separate the interior from the external environment, the first pane can face the interior or the external environment.

The first pane and/or, if present, the second pane can have further, suitable layers known per se, e.g., anti-reflective coatings, non-stick coatings, anti-scratch coatings, photocatalytic coatings or sun protection coatings, or low-e coatings. It shall be appreciated that further layers on the second main surface of the first pane must not impair the properties of the coating according to the invention and in particular the total reflection of light in the coating.

Furthermore, the glazing can optionally have further functional elements, in particular electronically controllable optical elements, for example PDLC elements, electrochromic elements or the like which are typically arranged between the first pane and the second pane.

Another aspect of the invention comprises a glazing assembly comprising a glazing according to the invention and a voltage source or control electronics connected to the light source. The voltage source or control electronics can control the light source so that it emits light when a voltage is applied.

Another aspect of the invention comprises a method for producing a glazing according to the invention, wherein at least
S1: the first pane is provided and
S2: the coating is deposited on the first main surface of the first pane by a thin-film deposition process.

In an advantageous embodiment of the method according to the invention, before the second method step (S2), a light source, preferably a laser diode and/or a light-emitting diode, is arranged on the second main surface of the first pane such that after the deposition of the coating in the second method step (S2), light can be coupled into the coating according to the invention. Particularly preferably, the light is coupled into the coating parallel to an extension direction of the coating.

For example, at least one prefabricated miniature light-emitting diode or miniature laser diode can be arranged on the second main surface of the first pane.

A simple light-emitting or laser diode has a p-n junction layer with an insulator in between, with two conductive layers on the top and bottom. Alternatively, a laser or light-emitting diode or a respective strip can be deposited directly on the first pane as a substrate using semiconductor production processes.

In another advantageous embodiment of the method according to the invention, the light or a portion of the light from the light source is coupled into the coating according to the invention at an angle θ greater than or equal to the angle θₜₒₜₐₗ of total reflection.

Another advantageous embodiment of the method according to the invention comprises the steps of:
arranging a light coupling means, preferably a light-scattering, light-reflecting, light-refracting or light-diffracting light coupling means, on the first main surface of the coating, preferably by laser structuring, mechanical structuring such as sandblasting, etching, coating, printing or applying a transparent body,
arranging at least one light source on the light coupling means and arranging at least one light outcoupling means on or in the coating.

The glazing according to the invention can be, for example, the roof pane, windshield, side window, or rear window of a vehicle or another vehicle glazing, for example a separating pane in a vehicle, preferably in a rail vehicle or a bus. Alternatively, the glazing can be an architectural glass, for example, in an outer façade of a building or a separating pane in the interior of a building, or a built-in part in furniture or devices.

Another aspect of the invention comprises using the glazing according to the invention in buildings, in particular in the access area, window area, roof area, or façade area, as a built-in component in furniture and devices, in means of transportation for travel on land, in the air, or on water, in particular in trains, ships, and motor vehicles, for example, as a windshield, rear window, side window, and/or roof pane.

In the following, the invention is explained in more detail with the aid of drawings and examples of embodiments. The drawings are schematic representations and are not true to scale. The drawings do not limit the invention in any way.

In the drawings:

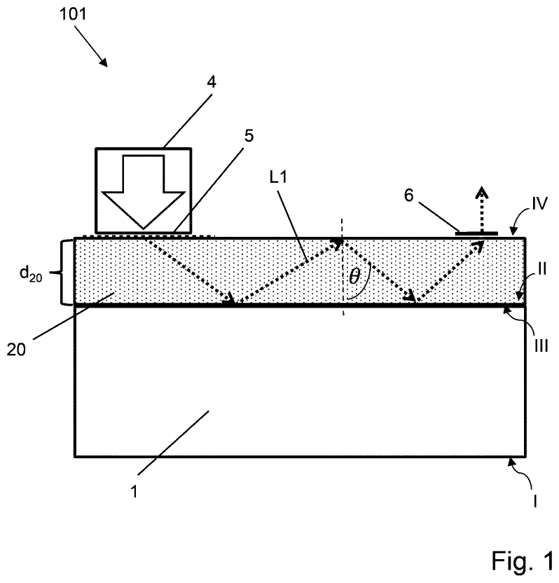

FIG. 1 shows a schematic cross-sectional view of an embodiment of a glazing according to the invention using the example of a single pane,

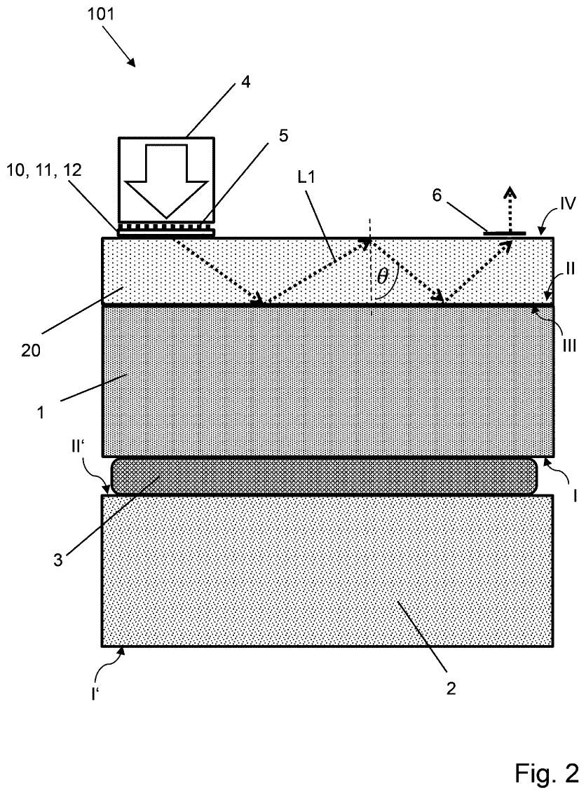

FIG. 2 shows a schematic cross-sectional view of another embodiment of a glazing according to the invention using the example of a laminated pane,

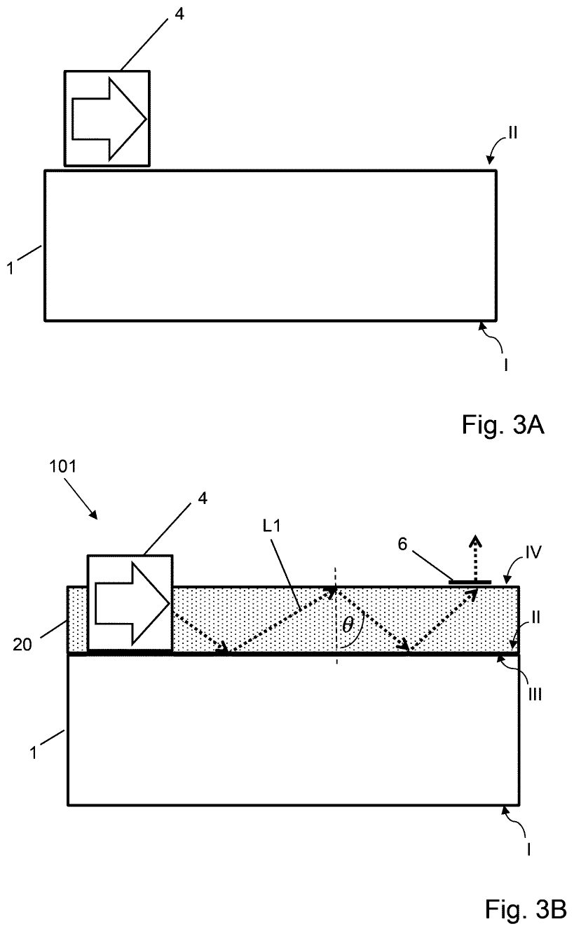

FIG. 3A, B show a schematic cross-sectional view of another embodiment of a glazing according to the invention using the example of a single pane to illustrate the method according to the invention, and

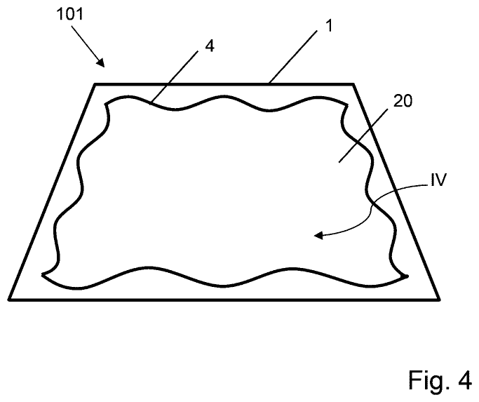

FIG. 4 shows a schematic plan view of the second main surface of a coating according to the invention of a glazing according to the invention with a light source arranged in a wave-shaped manner.

FIG. 1 (FIG. 1) shows a plan view of an exemplary embodiment of a glazing 101 according to the invention using the example of a single pane. The single pane can be, for example, an automobile glazing, a construction glazing or a component of a piece of furniture or (electrical) device. The glazing 101 is, for example, a roof pane of a vehicle. The glazing 101 can also be part of an insulating glazing unit and can serve, for example, as an outer pane or inner pane in a window of a building. Alternatively, the glazing 101 can be arranged in an interior and be, for example, a glazing of a conference room.

The glazing 101 contains a pane 1, which is also referred to as first pane 1 in the context of the present invention. The dimensions of the first pane 1 are, for example, 1.4 m×1.5 m. The first pane 1 consists, for example, of soda lime glass. The thickness of the first pane 1 is 3 mm, for example. It shall be appreciated that the thickness of the first pane 1 can be adapted to the particular use. The first pane 1 can contain, for example, prestressed, partially prestressed or non-prestressed glass. Alternatively, the first pane 1 can consist of a plastic, for example polycarbonate.

The first pane 1 has a first main surface I and a further opposite second main surface II. The first pane 1 is further limited by four circumferential side surfaces which are arranged orthogonal to the main surfaces I, II.

A coating 20 according to the invention is arranged on the first pane 1. The second main surface II of the first pane 1 is in direct contact with the first main surface III of the coating 20.

The first pane 1 consists, for example, of tinted glass with a 10% transmission when viewed through the first pane 1.

The coating 20 consists, for example, of aluminum oxide (Al₂O₃) and has, for example, a thickness d₂₀ of 1 μm.

The refractive index n₂₀ of the coating 20 is, for example, 1.76 at a wavelength of 550 nm, and the refractive index n₁ of the first pane 1 is, for example, 1.51 at a wavelength of 550 nm. The refractive index n₂₀ of the coating 20 is thus 0.25 greater than the refractive index n₁ of the first pane 1.

The extinction coefficient k₂₀ of the coating 20 is smaller than the extinction coefficient k₁ of the first pane 1 in the entire wavelength range of visible light, i.e., in the range between 380 nm and 780 nm.

The extinction coefficient k₂₀ of the coating 20 is, for example, <1*10⁻⁹ at a wavelength of 550 nm, and the extinction coefficient k₁ of the first pane 1 is, for example, 2.3*10⁻⁵ at the same wavelength of 550 nm. At the wavelength of 550 nm, the extinction coefficient k₂₀ of the coating 20 is thus smaller by a factor of more than 20,000 than the extinction coefficient k₁ of the first pane 1.

The glazing 101 comprises a light source 4, for example a light-emitting diode (LED), which emits light in the visible range, for example. The light beam from the light source 4 is directed in the direction of the coating 20 and strikes the second main surface IV of the coating 20 substantially orthogonally.

For example, a light coupling means 5 is arranged between the light source 4 and the coating 20, and, by scattering, reflection, refraction or diffraction, couples a large part of the light from the light source 4 into the first pane 1 at an angle θ (theta) greater than or equal to the angle of total reflection θₜₒₜₐₗ. The angle of total reflection θₜₒₜₐₗ depends on the refractive index of the light-conducting medium and is approximately 59° for the present coating 20 (n=1.76) to the first pane 1 (n=1.51).

Due to the principle of total reflection, all light coupled into the coating 20 at an angle θ≥θₜₒₜₐₗ propagates through the coating 20 without losses at the interfaces. In FIG. 1, this is shown schematically by the light beam L1. Attenuation of the coupled light occurs only through extinction within the medium of the coating 20.

The light coupling means 5 can be designed in different ways. In the present exemplary embodiment, it consists of a region of the second main surface IV of the coating 20, in which scattering centers have been introduced into the second main surface IV by laser structuring.

For example, a light outcoupling means 6 is arranged on the second main surface IV of the coating 20. The light outcoupling means 6 can be arranged at any desired location on the first main surface III or second main surface IV of the coating 20 and is in particular arranged offset from the light coupling means 5 (i.e., not directly opposite).

Light coupling means 5 according to the invention are known to those skilled in the art, for example from WO 2022/096365 A1, so that they will not be discussed in more detail herein.

A light coupling means 5 can be introduced into the second main surface IV of the coating 20 for example by laser structuring. For that purpose, for example, a diffraction grating having a periodicity of 1 μm and a trench depth of 100 nm is structured into the surface. For this purpose, for example, a short-pulse laser is moved in a linear pattern over the main surface IV. Alternatively, a diffuse-scattering surface structuring can be introduced into the surface by local removal. For this purpose, a short-pulse laser with a power of 10 watts was moved in a grid-like pattern over the second main surface IV.

Alternatively, a transparent body can be arranged as a light coupling means 5 between the light source 4 and the coating 20. The surface of the transparent body facing the light source 4 has, for example, a step prism which is suitable for refracting a large part of the light from the light source 4 and coupling it into the coating 20 at an angle θ≥θₜₒₜₐₗ. For this purpose, the pane contact surface of the transparent body is flat and bonded directly to the main surface IV of the coating 20. The transparent body consists, for example, of a plastic and in particular of a photopolymer, into which the step prism is introduced by suitable microstructuring or exposure processes.

For example, structurings of the main surface III, IV of the coating 20 are suitable as light outcoupling means 6, where total reflection is prevented and light can exit the coating 20 via the respective main surface III, IV. Alternatively, the light outcoupling means 6 can comprise an imprint on the coating 20 or light-scattering, light-refracting, light-diffracting or light-reflecting particles, scattering centers, cavities or unevennesses introduced into the coating 20. Such scattering centers, cavities or unevennesses can be introduced into or onto the coating 20, for example, by laser structuring.

In the present exemplary embodiment, the light outcoupling means 6, for example, is designed as an imprint of fine light-scattering particles on the second main surface IV of the coating 20. As a result, the total reflection of the light beam L1 is interrupted at the interface between the coating 20 and the surrounding air, and light is coupled out of the coating 20 by scattering.

In one embodiment of the invention, the glazing 101 can comprise light amplification means (not shown) which is arranged opposite the coating 20 of the light source 4. The light amplification means has the task of redirecting a large part of the light, which penetrates the coating 20 at an angle θ<θₜₒₜₐₗ and immediately exits again due to a lack of total reflection at the interface (here the first main surface III) opposite the entrance surface, back into the coating 20, preferably at an angle θ≥θₜₒₜₐₗ. The light amplification means preferably uses mechanisms of reflection, refraction, diffraction and/or scattering. Such light amplification means are known to those skilled in the art, for example from WO 2022/096365 A1, so that they will not be discussed in more detail herein.

The light amplification means significantly increases the intensity of the light coupled into the coating 20 under total reflection and thus also the intensity of the light that can be coupled out.

FIG. 2 (FIG. 2) shows a schematic cross-sectional view of another embodiment of a glazing according to the invention using the example of a laminated pane. FIG. 2 shows a development according to the invention of the glazing 101 of FIG. 1. The glazing 101 of FIG. 1 has a similar structure to the glazing 101 of FIG. 2, so that only the differences will be discussed below and otherwise reference will be made to the description of FIG. 1.

In contrast to the glazing 101 of FIG. 1, the first pane 1 in FIG. 2 is connected via an intermediate layer 3 to a second pane 2 by lamination, for example in an autoclave. The intermediate layer 3 is firmly connected on the one side to the first main surface I of the first pane 1 and on the opposite side to the second main surface II′ of the second pane 2.

The dimensions of the glazing 101 are, for example, 1.6 m×1.5 m. The first pane 1 is, for example, provided to face the interior of a vehicle when in the installed position. In other words, the second main surface II of the first pane 1 is accessible from the interior, whereas, in contrast, the first main surface I′ of the second pane 2 faces outward relative to the vehicle interior. The first pane 1 and the second pane 2 consist, for example, of soda lime glass. The thickness of the first pane 1 is, for example, 1.6 mm and the thickness of the second pane 2 is, for example, 2.1 mm. It is understood that the first pane 1 and the second pane 2 can have any desired thickness and, for example, can also be of the same thickness. The intermediate layer 3 preferably consists of an acoustically dampening 3-layer PVB film. The second pane 2 and the intermediate layer 3 are for example clear, i.e., neither tinted nor colored.

In this example, the light coupling means 5 consists of a transparent body 10 which contains a plastic film 12 which is glued to the second main surface IV of the coating 20. The plastic film 12 is, for example, printed with light-scattering particles that diffusely scatter the light from the light source 4.

For example, the light outcoupling means 6 is here also arranged on the second main surface IV of the coating 20. It shall be appreciated that it can also be arranged on the first main surface III of the coating 20 or within the coating 20.

The glazing 101 shown in FIG. 2 is particularly well-suited as a roof pane of a motor vehicle. For this purpose, for example, a functional element with electrically controllable optical properties such as a PDLC functional element can be arranged between the first pane 1 and the second pane 2.

FIG. 3A (FIGS. 3A) and 3B (FIG. 3B) show a schematic cross-sectional view of another embodiment of a glazing 101 according to the invention using the example of a laminated pane and illustrate the method steps according to the invention of a production method according to the invention. FIGS. 3A and 3B show an embodiment according to the invention of the glazing 101 of FIG. 1. The glazing 101 of FIG. 1 has a similar structure to the glazing 101 of FIG. 3B, so that only the differences will be discussed below and otherwise reference will be made to the description of FIG. 1.

In the method according to the invention for producing a glazing 101 according to the invention, a first pane 1 is provided in a first method step S1 and a coating 20 according to the invention is deposited on the second main surface II of the first pane 1 by a thin-film deposition process in a subsequent second method step S2.

FIG. 3A shows the first pane 1 during the first method step S1, wherein a light source 4 in the form of an LED has moreover been arranged on the second main surface II of the first pane 1. For example, the LED was glued as a finished component onto the first main surface II of the first pane 1. Alternatively, the LED can also be manufactured directly on the first pane 1 using appropriate semiconductor construction processes.

Subsequently, in a second method step S2, the coating 20 according to the invention is deposited on the second main surface II of the first pane 1.

FIG. 3B shows the finished glazing 101 according to the invention. The light source 4, i.e., the LED, was arranged on the second main surface II of the first pane 1 such that after deposition of the coating 20 in the second method step S2, the light from the light source 4 can be coupled into the coating 20. This means that the light source 4 can, for example, couple its light substantially parallel to the extension direction of the main surfaces of the coating 20 (i.e., into an end face of the coating 20 and thus at an angle Ototal of the total reflection in the coating 20.

FIG. 4 (FIG. 4) shows a schematic plan view of another glazing 101 according to the invention in a plan view of the main surface IV of the coating 20.

The light source 4 is designed as a strip of individual LEDs that are arranged in a wave-shaped manner in the outer region of a windshield. The wave shape increases the length of the strip and thus the number of light sources 4, so that overall more light can be coupled into the coating 20 and thus more light can be coupled out of the coating 20 via light outcoupling elements 6. Alternatively, the light source 4 can be meandering, sinusoidal or zigzag-shaped.

The glazing 101 according to the invention with the coating 20 according to the invention has a number of advantages over glazings from prior art:
coatings according to the invention can be produced in a simple and cost-effective manner;
the reduction in light intensity within a single pane is reduced by using a coating with a lower extinction coefficient;
glazings according to the invention are easier to recycle, in particular when using glass-based coatings compared to polymer-based coatings;
suitable light outcoupling means (patterns, structures) can be introduced into or onto the coating easily and cost-effectively, for example by direct laser structuring.

This was unexpected and surprising for the person skilled in the art.

### LIST OF REFERENCE SIGNS

1 First pane
2 Second pane
3 Intermediate layer
4 Light source
5 Light coupling means
6 Light outcoupling means
10 Transparent body or reflective body
11 Step prism
12 Plastic film
20 Coating
10 Glazing
L1 Light beam
θ Angle (theta)
θₜₒₜₐₗ Angle (theta) of total reflection
k₁ Extinction coefficient of the first pane 1
k₂₀ Extinction coefficient of the coating 20
n₁ Refractive index of the first pane 1
n₁₀ Refractive index of the transparent or reflective body 10
n₂₀ Refractive index of the coating 20
I First main surface, outer-side surface of the first pane 1
II Second main surface, inner-side surface of the first pane 1
I′ First main surface, outer-side surface of the second pane 2
II′ Second main surface, inner-side surface of the second pane 1
III First main surface, outer-side surface of the coating 20
VI Second main surface, inner-side surface of the coating 20

1. A glazing comprising:
at least a first pane having a first main surface and a second main surface,
a coating having a first main surface (III) and a second main surface, wherein the coating is arranged with the first main surface on the second main surface of the first pane,
at least one light source, wherein the light source is connected to the coating such that light from the light source can be coupled into the coating, and
at least one light outcoupling means for coupling light out of the coating via at least one of the main surfaces of the coating,
wherein, for at least one wavelength λ of a light from the light source,
a refractive index n₂₀ of the coating is greater than a refractive index n₁ of the first pane, and
an extinction coefficient k₂₀ of the coating is smaller than an extinction coefficient k₁ of the first pane.

2. The glazing according to claim 1, wherein the light source is connected to the coating such that the light from the light source can be coupled at an angle θ greater than or equal to the angle θₜₒₜₐₗ of total reflection in the coating.

3. The glazing according to claim 1, wherein the light source is suitable for emitting light with at least one wavelength λ in the wavelength range of visible light.

4. The glazing according to claim 1, wherein the extinction coefficient k₂₀ is smaller than the extinction coefficient k₁ by a factor of at least 1.5.

5. The glazing according to claim 1, wherein the extinction coefficient k₂₀ at a wavelength λ of 550 nm is less than or equal to 1*10⁻⁶.

6. The glazing according to claim 1, wherein the coating has a thickness d₂₀ of at least the wavelength λ of the light from the light source.

7. The glazing according to claim 1, wherein the coating is deposited on the first pane by a thin-film deposition process.

8. The glazing according to claim 1, wherein the coating contains or consists of
titanium oxide,
aluminum oxide,
silicon nitride,
silicon zirconium nitride, or
silicon dioxide.

9. The glazing according to claim 1, wherein the refractive index n₂₀ of the coating is at least 0.1, greater than the refractive index n₁ of the first pane.

10. The glazing according to claim 1, wherein the light source contains or consists of a light-emitting diode, an incandescent lamp and/or a gas discharge lamp.

11. The glazing according to claim 1, wherein the light outcoupling means is designed to couple out light guided in the coating on at least one of the main surfaces of the coating.

12. The glazing according to claim 1, wherein the light outcoupling means
is introduced into the first main surface and/or into the second main surface by laser structuring, mechanical structuring or by etching, and/or
is integrally connected to the first main surface and/or the second main surface of the coating by printing or gluing of a colorant, a paste or particles, and/or
is arranged within the coating by light-scattering, light-refracting or light-reflecting particles, scattering centers and/or cavities within the coating, and/or
is a transparent body which is connected to the second main surface of the coating wherein the transparent body contains or consists of
a) a structured plastic film or plastic plate, or
b) a transmission-holographic film, and/or
is a reflective body which is connected to the second main surface of the coating wherein the reflective body contains or consists of
a) a structured plastic film or plastic plate, or
b) a reflection-holographic film,
and/or
is a transparent body which is connected to the second main surface of the coating, wherein the transparent body has or consists of a structured directionally refracting, transparent layer, plastic film or plastic plate
and the refractive index n_{10′} of which is significantly greater than n₁.

13. The glazing according to claim 1, wherein a second pane is connected to the first main surface of the first pane by at least one intermediate layer.

14. The glazing according to claim 1, wherein the first pane and/or the second pane contains or consists of glass or polymers and/or mixtures or combinations thereof.

15. The glazing according to claim 1, wherein the light source is connected to the coating directly or via a light coupling means.

16. A method for producing a glazing according to claim 1, the method comprising:
providing the first pane, and
depositing the coating on the first main surface of the first pane by a thin-film deposition process.

17. The method according to claim 16, wherein before the depositing, a light source is arranged on the second main surface of the first pane such that after deposition of the coating, light can be coupled into the coating.

18. The use of the glazing according to claim 1 in a vehicle of transportation for travel on land, in the air, or on water.

19. The glazing according to claim 3, wherein the light source is suitable for emitting light with at least one wavelength λ in the wavelength range of 380 nm to 780 nm.

20. The glazing according to claim 4, wherein the extinction coefficient k₂₀ is smaller than the extinction coefficient k₁ by a factor of at least 5.
